(19) United States
(12) Patent Application Publication
(10) Pub. No.: US 2011/0068612 A1
(43) Pub. Date: Mar. 24, 2011

(54) FITTING FOR A VEHICLE SEAT

(76) Inventor: Peter Thiel, Remscheid (DE)

(21) Appl. No.: 12/674,037

(22) PCT Filed: Jan. 14, 2009
(86) PCT No.: PCT/EP2009/000161

§ 371 Date: Feb. 18, 2010

(30) Foreign Application Priority Data
Feb. 8, 2008 (DE) 10 2008 008 935.4

(51) Int. Cl. B60N 2/20; B60N 2/22; B60N 2/12

(52) U.S. Cl. 297/344.1; 297/354.12

(57) ABSTRACT

A fitting (5) for a vehicle seat (1), in particular for a motor vehicle seat, includes an adjustment fitting (11) for adjusting the inclination of the backrest (2) of the vehicle seat (1) in relation to a seat part (3) of said vehicle seat. A free-pivoting unit (12) is provided for freely pivoting the backrest (2) centrally (2) from at least one operating position into a free-pivoting position, that can be released by means of a free-pivoting operational element (8). A fitting lower part (9) is provided that is to be connected to the seat part (3) and that supports the adjustment fitting (11) and a fitting upper part (14) is associated with the free-pivoting unit (12) that is to be connected to the backrest (2) and that is locked in the operating position. A fastening catch (64) is coupled in a pivotable manner to the fitting upper part (14); and which fastens the fitting upper part (14) in the free-pivoting position of the backrest (2). The fastening catch (64) is then opened by at least the free-pivoting operating element (8), the fastening catch (64) fastening the fitting upper part (14) to the fastening lower part (9) and is then opened by a longitudinal adjusting element (81) of the vehicle seat (1).

### CROSS REFERENCE TO RELATED APPLICATIONS

This application is a U.S. National Phase application of International Application PCT/EP2009/000161 and claims the benefit of priority under 35 U.S.C. §119 of German Patent Application DE 10 2008 008 935.4 filed Feb. 8, 2008, the entire contents of which are incorporated herein by reference.

### FIELD OF THE INVENTION

The invention relates to a fitting for a vehicle seat, in particular for a motor vehicle seat, comprising an adjustment fitting for the inclination adjustment of a backrest of the vehicle seat relative to a seat part of the vehicle seat.

### BACKGROUND OF THE INVENTION

A fitting of this type for a two-door motor vehicle is known from DE 102 06 303 A1, which is used to permit access to the rear by means of the backrest freely pivoting in the forward direction, and to provide different inclination adjustments of the backrest for use by a passenger. In order to prevent undesired pivoting-back of the backrest, for example when the cushioning in the transition region between the backrest and the seat part is too great, a securing of the backrest is provided in the freely-pivoted position.

### SUMMARY OF THE INVENTION

The object of the invention is to improve a fitting of the aforementioned type.

The securing latch is preferably able to be opened automatically by means of the longitudinal adjuster of the vehicle seat, in particular when the longitudinal adjuster moves the vehicle seat into the previously set longitudinal seat position, which is recognized by a memory device. Moreover, the securing latch may be opened manually by means of the freely-pivoting operating element, in particular in specific situations when, for example, the previously set longitudinal seat position is no longer reached. The securing latch thus has two alternative possibilities for opening. A freely-pivoted position, independent of the set inclination of the backrest, results when the fitting upper part is secured to the fitting lower part.

The adjustment fitting preferably has two fitting parts which are connected to one another in transmission, for example by means of a self-locking eccentric epicyclic gear, and which are rotatable relative to one another. For limiting the inclination adjustment, preferably a stop is provided on the fitting lower part and a detent element cooperating with the stop is provided on the adjustment fitting. The stop is preferably fixedly connected to the fitting lower part (and thus to the fitting part of the adjustment fitting fixed to the seat part), for example by being formed on the fitting lower part (or a component fastened thereto) (i.e. integrally formed) or separately formed and fastened thereto. The detent element is preferably fixedly connected to the fitting part of the adjustment fitting not fixed to the seat part, for example by being formed on the fitting part of the adjustment fitting not fixed to the seat part (or a component fastened thereto) (i.e. integrally formed) or separately formed and fastened thereto.

The stop and detent element are preferably effective in both adjustment directions, for example by a corresponding number of stop surfaces. The stop may, for example, be arranged within a recess of the detent element. More specifically, the detent element may have on one part of its periphery a recess offset radially inwards, defined in each case by a step, within which the stop—preferably projecting axially from the fitting lower part—might be arranged. By the cooperation of the stop with the steps of the detent element, the angle for the inclination adjustment of the backrest is limited.

The freely-pivoting unit preferably comprises a locking device with a latch for locking the fitting upper part in the position of use, a prestressed clamping element for securing the locked latch normally and a catch element for supporting the latch in the event of a crash. The latch is preferably pivotably articulated to the fitting upper part and locked to a detent element of the freely-pivoting unit. Preferably, said detent element at the same time is the detent element which cooperates with the stop for limiting the inclination adjustment. The dual function dispenses with a further component. Preferably, a cover is provided which is connected to the fitting upper part and covers the locking device. The adjustment fitting is connected with its two fitting parts which are rotatable relative to one another, on the one hand, preferably fixedly to the detent element and, on the other hand, fixedly to the fitting lower part. Thus the freely-pivoting unit may be produced and tested as a pre-assembled sub-assembly. If this is not important, the detent element may be formed on the fitting part of the adjustment fitting which is not fixed to the seat part.

For unlocking the latch, a release element is preferably provided, the rotation thereof about its own axis preferably pivoting the catch element away from the latch. The clamping element is preferably coupled so that it may be carried along with free travel, for example by means of a slotted pin guide, so that it is ultimately also pivoted away from the latch by the rotating release element, thus unlocking said latch. A bearing bush is provided for mounting the release element and the clamping element. The preferred mounting of the release element inside the bearing bush and the clamping element on the outside on the bearing bush has the advantage that, at the start of the rotation of the release element, the clamping element is not already inadvertently carried along, for example due to friction, but only when the free travel has been passed. Moreover, if the clamping element were to be pivoted away in the event of a crash, the catch element would be able to remain unaffected in its position.

The securing latch preferably cooperates with a stop on the fitting lower part for securing the fitting upper part. This simplifies the coupling to the longitudinal adjuster. The stop is preferably said stop for limiting the inclination adjustment which, for example, is arranged within a recess of the detent element. The dual function dispenses with a further component.

The securing latch in the position of use preferably bears against a component of the freely-pivoting unit, for example the detent element or a switching ring, which is advantageous for the freely-pivoting unit as a pre-assembled sub-assembly. During the free-pivoting of the backrest, when reaching the stop the securing latch may pivot slightly upwards with the further pivoting movement of the backrest and slide along the underside of the stop, until it engages behind the stop after passing the stop. However, other possibilities for the cooperation of the securing latch and the stop are also possible. The securing latch and the stop preferably cooperate outside the self-locking region. Prestressing may ensure a non-positive cooperation. Thus it is respectively ensured that the securing latch opens by a relative movement of the fitting upper part and stop and/or above a marginal force.

The securing latch is preferably secured by an operating lever, which is preferably prestressed. The securing may take place positively or non-positively. The securing latch secured by the operating lever may be opened, by the cooperation of the securing latch and the operating lever being cancelled, for example by the operating lever being pivoted away from the securing latch. This may take place automatically in the presence of specific conditions, for example in a specific longitudinal seat position, so that the backrest may then be pivoted back into its initial position.

By means of a rotatable switching ring which, during the actuation of the freely-pivoting operating element cancels the cooperation of the securing latch and the operating lever, the securing may be manually terminated. The rotation of the switching ring is, for example, effected by the catch element, for which said two components preferably have projections with suitably higher sides. The rotated switching ring preferably acts by means of a switching contour on the operating lever, in order to remove said operating lever from the securing latch.

The invention may be used preferably in longitudinally adjustable vehicle seats of two-door motor vehicles with central free-pivoting of the backrest, but also may be used for other vehicle seats. With a use of the fitting according to the invention for activating the so-called “easy entry function”, in which apart from a free-pivoting of the backrest a movement of the vehicle seat takes place, the backrest may be pivoted back exactly when the previously set longitudinal seat position is reached.

The invention is described in more detail hereinafter with reference to an embodiment shown in the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1A is an exploded view of the embodiment without control cables;

FIG. 1B is a perspective view of an unlocking ring;

FIG. 2 is a section through the embodiment along the line II-II in FIG. 4, in a position of use in a locked state;

FIG. 3 is a section through the upper part of the embodiment along the line III-III in FIG. 4;

FIG. 4 is a lateral view of the embodiment;

FIG. 5 is a part of a section through the embodiment during unlocking, for free-pivoting of the backrest;

FIG. 6 is a part of a section through the embodiment during the free-pivoting of the backrest;

FIG. 7 is a section through the embodiment according to FIG. 2 in a secured state in the freely pivoted position of the backrest;

FIG. 8 is a part of a section through the embodiment when automatically opening the securing by means of the longitudinal adjuster;

FIG. 9 is a part of a section through the embodiment when manually opening the securing by means of the freely-pivoting operating element, the detent element not being shown;

FIG. 10 is a schematic side view of a vehicle seat;

FIG. 11 is a side view of the embodiment according to FIG. 7, without the detent element in a secured state in the freely-pivoted position of the backrest, the adjustment fitting adopting an upper position in its wobble loop; and

FIG. 12 is a side view of the embodiment according to FIG. 11, the adjustment fitting adopting a lower position in its wobble loop.

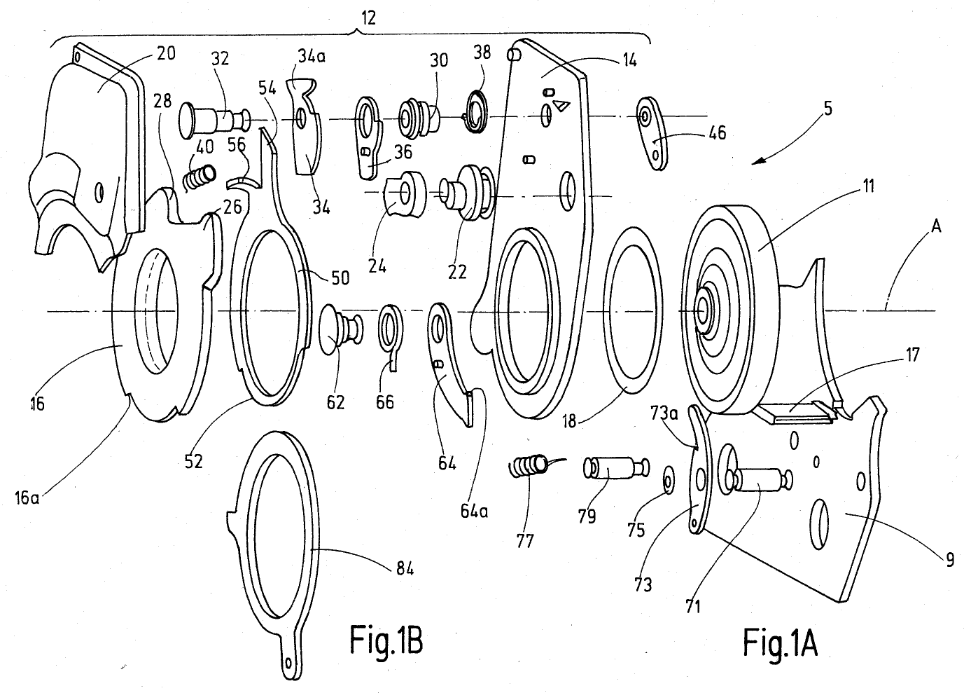

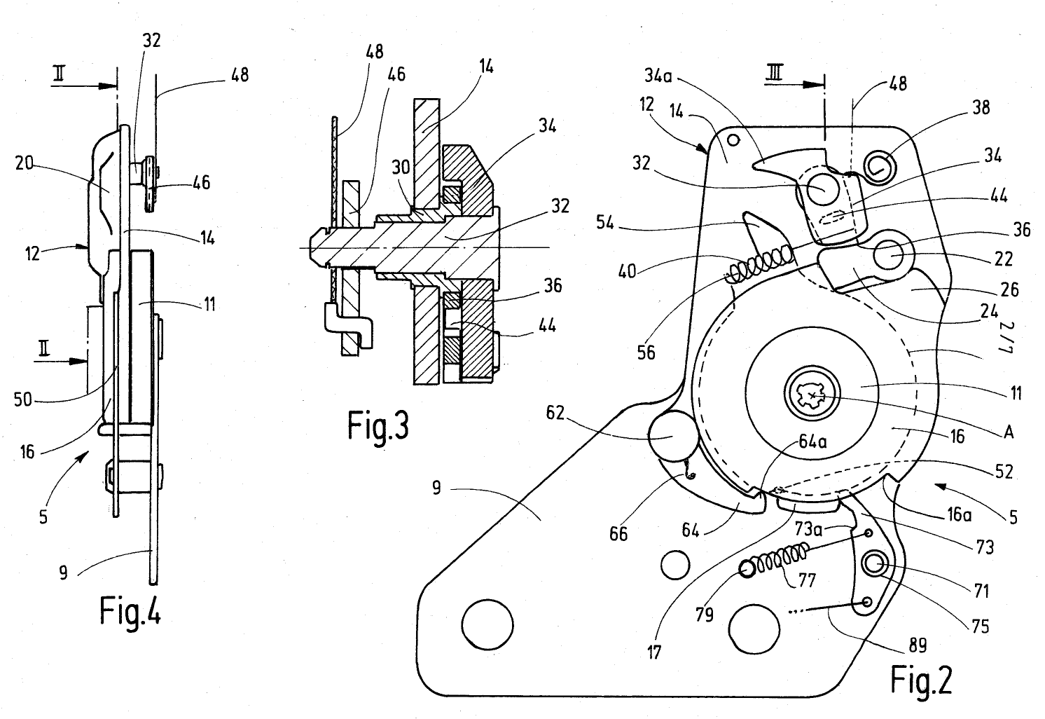

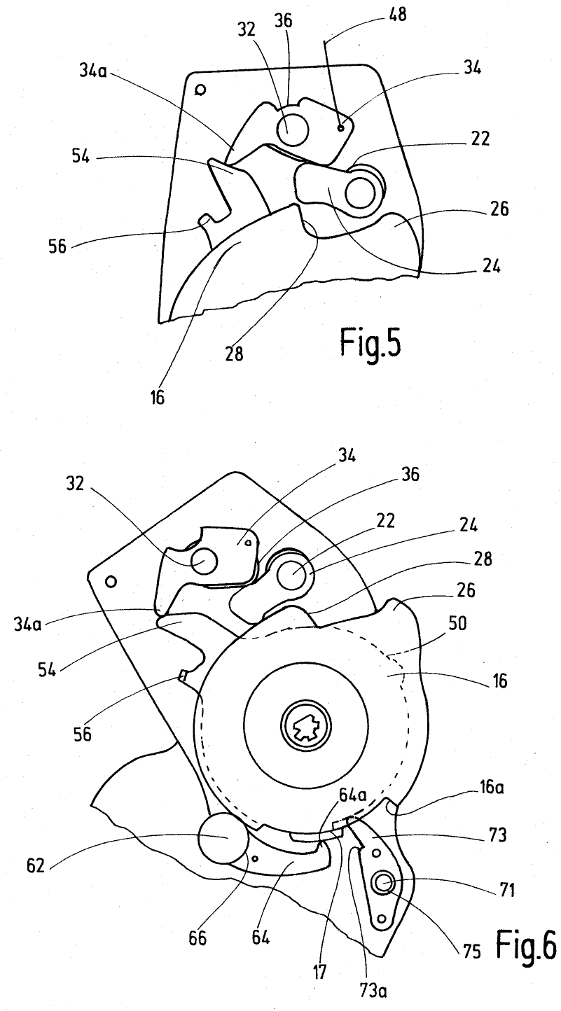

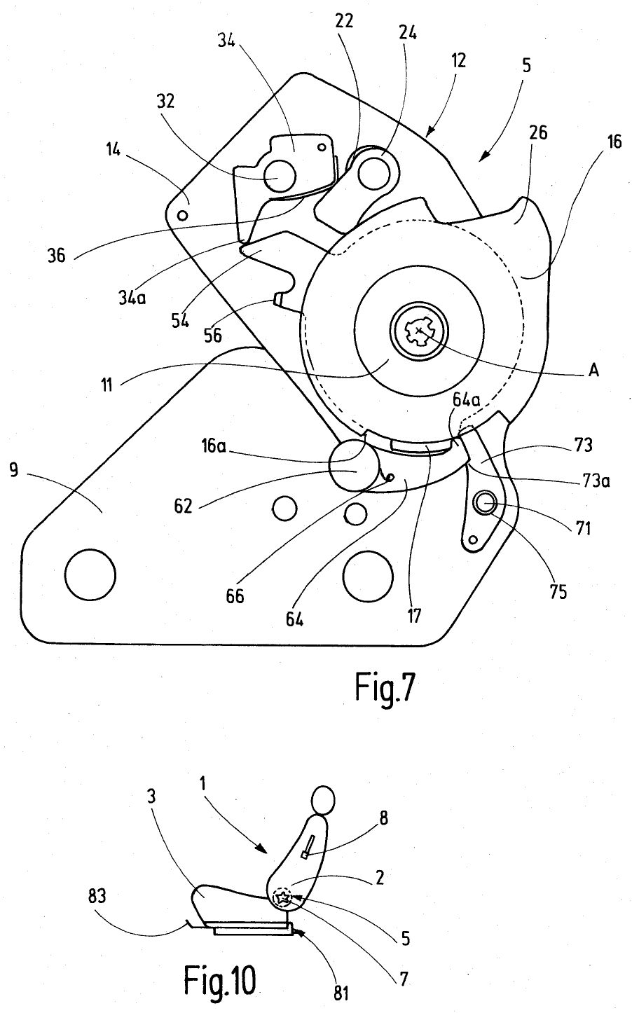

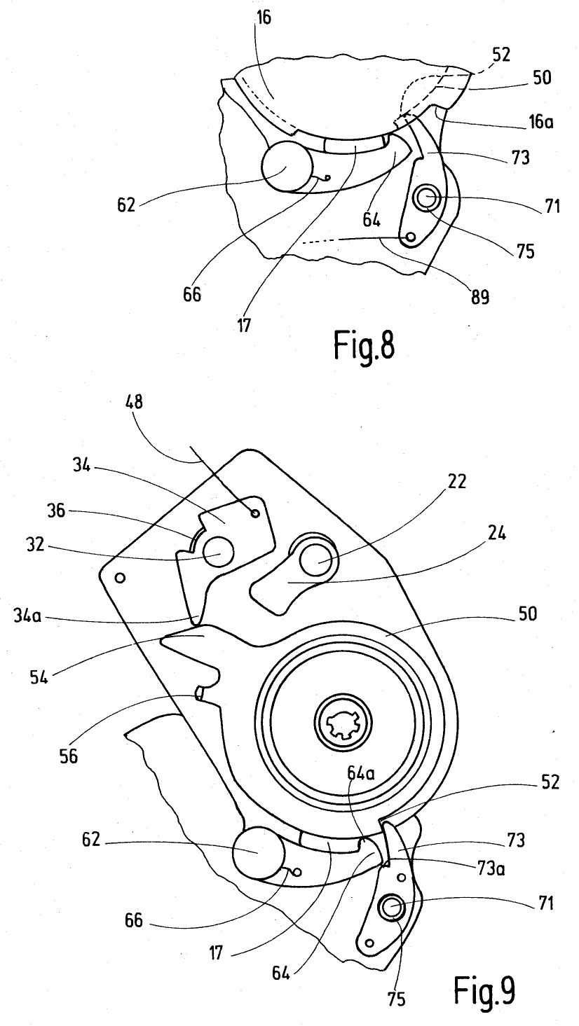

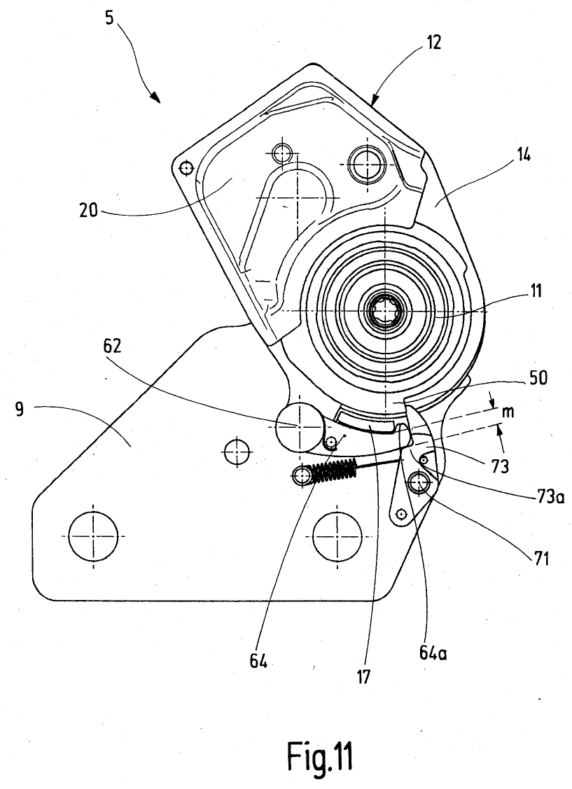

### DESCRIPTION OF THE PREFERRED EMBODIMENTS

Referring to the drawings in particular, a vehicle seat 1 for a two-door motor vehicle for the inclination adjustment, i.e. the slow, small angular alteration between a plurality of positions of use and free-pivoting, i.e. the rapid, large angular alteration from a position of use into a freely-pivoted position as a specific position of non-use, of its backrest 2 relative to its seat part 3 has on both of its sides one respective fitting 5. On the outside of the vehicle seat 1, for the inclination adjustment function on one of the fittings 5, a handwheel 7 is provided and between both fittings 5 a shaft connected to the handwheel 7, whilst for the free-pivoting function a freely-pivoting operating element 8, for example a hand lever, is movably attached to the backrest 2.

Each fitting 5 comprises a fitting lower part 9 which serves for fastening the fitting 5 to the structure of the seat part 3 (“fixed to the seat part”), a backrest inclination adjustment fitting, denoted in short hereinafter as an adjustment fitting 11, and a freely-pivoting unit 12 which in turn has a fitting upper part 14, which is used for fastening the fitting 5 to the structure of the backrest 2 (“fixed to the backrest”).

The adjustment fitting 11 is formed in terms of structure as a disc-shaped unit, as is disclosed for example in DE 101 05 282 B4, the disclosure thereof being expressly included in the invention (corresponding U.S. Pat. No. 6,799,806 is incorporated by reference). The adjustment fitting 11 has two fitting parts which may be rotated relative to one another and are held together by means of a clamping ring in the axial direction. In the embodiment, the adjustment fitting 11 is configured as a geared fitting, i.e. the two fitting parts of the adjustment fitting 11 are connected to one another in transmission by means of an eccentric epicylic gear—which is self-locking here—and which in the present case permits a securing without clearance of the two fitting parts of the adjustment fitting 11, and for the stepless adjustment forces a relative rotation of the two fitting parts of the adjustment fitting 11 with a superimposed wobble motion. The path of this wobble motion might be denoted as a wobble loop. Such a geared fitting is, for example, disclosed in DE 44 36 101 A1, the disclosure thereof being expressly included in the invention (corresponding U.S. Pat. No. 5,634,689 is incorporated by reference). The rotation of the handwheel 7 drives the geared fitting. However, other geared fittings and—in theory—also detent fittings may also be used as adjustment fittings 11. In the latter case, a small rotation of the handwheel 7 or a lever provided as an alternative unlocks the detent fitting. The adjustment fitting 11 is connected by one of its two fitting parts and the clamping ring fixedly to the fitting lower part 9, i.e. one of the two fitting parts of the adjustment fitting 11 is fixed to the seat part. To this end, the fitting lower part 9 has a fork-shaped receiver for the adjustment fitting 11.

The freely-pivoting unit 12 has an—approximately annular—detent element 16, relative to which the fitting upper part 14 is rotatably mounted about an axis A. The axis A and its position within the vehicle seat 1 define the directional information used in the present case. As the axis A—possibly apart from the wobble motion, coincides with the central axis of the adjustment fitting 11, in the present case central free-pivoting is present. A stop 17 is fastened to the fitting lower part 9 and projects therefrom axially. The detent element 16 has on one part of its periphery a recess 16a offset radially to the inside, defined in each case by a step, within which the stop 17 is arranged. By the cooperation of the stop 17 with the steps of the detent element 16, the angle for the inclination adjustment of the backrest 2 is defined. The detent element 16 (and thus the freely-pivoting unit 12) is fixedly connected to that of the two fitting parts of the adjustment fitting 11, which is not fixed to the seat part. The connection of the freely-pivoting unit 12 to the adjustment fitting 11 takes place, for example, by laser welding.

For the mounting of the fitting upper part 14, the detent element 16 in the present case has a collar projecting axially relative to the axis A, on which the fitting upper part 14 is rotatably mounted. The fitting upper part 14 also has a collar which projects towards the detent element 16, so that between the detent element 16 and the fitting upper part 14 a constructional space is present. A retaining disc 18 serves as axial securing of the fitting upper part 14. The retaining disc 18 configured as an annular disc is connected to the detent element 16 after positioning the fitting upper part 14 on the collar of the detent element 16, said retaining disc engaging behind the fitting upper part 14. A cover 20 connected to the fitting upper part 14 defines, on the one hand, a constructional space between itself and the fitting upper part 14 projecting upwards over the detent element 16. On the other hand, the lower edge of the cover 20 is configured as a retaining clamp, and engages over the detent element 16, possibly by the interposition of a slider, for example made of plastics. The cover 20 is thus used as further axial securing of the fitting upper part 14.

On the fitting upper part 14 by means of a bearing pin 22 a latch 24 is pivotably mounted, which may be locked to the detent element 16. The bearing pin 22 parallel to the axis A defines at the same time the pivoting motion of the fitting upper part 14 to the rear, and namely both normally and also in the event of a (rear) crash, by bearing against a first detent stop 26 of the detent element 16. For locking the latch 24 and for limiting the pivoting motion of the fitting upper part 14 to the front in the event of a (front) crash, a second detent stop 28 is provided in the radial extension of the latch 24 on the detent element 16. The latch 24 is locked to the detent element 16, on the one hand, by being supported by means of the bearing pin 22 on the first detent stop 26 and, on the other hand, by bearing with its free end on the second detent stop 28 without clearance. To this end, the bearing take place at an angle outside the self-locking region. An alternative support on the first detent stop 26 may be implemented by means of a shaping or the like of the fitting upper part 14. Both detent stops 26 and 28 are formed in the present case on the detent element 16, i.e. configured integrally therewith. The bearing pin 22 is configured as an eccentric pin, i.e. it is rotatably mounted in the fitting upper part 14 about an axis which is offset relative to the pivot axis of the latch 24, relative to said fitting upper part. For compensating for production tolerances, the bearing pin 22 is adjusted and fixed such that the latch 24 bears with maximum latch engagement on the second detent stop 28.

In the fitting upper part 14 a bearing bush 30 is preferably located fixedly in terms of rotation which, for example, is riveted or welded into an opening of the fitting upper part 14. A release element 32 is rotatably mounted by means of this bearing bush 30, parallel to the axis A and to the bearing pin 22. On the release element 32 is located fixedly in terms of rotation or configured in one piece with the release element 32, a catch element 34, whilst a clamping element 36—arranged axially adjacent to the catch element 34—is mounted pivotably on the bearing bush 30. Thus the release element 32 is mounted inside the bearing bush 30 and the clamping element 36 externally on the bearing bush 30. The catch element 34 and the clamping element 36 are aligned with the latch 24 when the fitting upper part 14 is locked. The mode of operation of the catch element 34 and the clamping element 36 is disclosed in DE 44 39 644 A1, the disclosure thereof being expressly included in the invention (corresponding U.S. Pat. No. 4,223,947 is incorporated by reference). The clamping element 36 bears with a clamping surface curved eccentrically relative to the release element 32 at an angle outside the self-locking region on a bearing surface of the latch 24. The clamping element 36 is acted upon by a tension spring 38 formed as a helical spring, so that the clamping element 36 bears with pretensioning against the latch 24. As a result, the fitting upper part 14 is locked without clearance to the detent element 16. The catch element 34 is acted upon by an arresting spring 40 configured as a helical-tension spring. The catch element 34 and the clamping element 36 are coupled to one another to be carried along with free travel by means of a slotted pin guide 44. To this end, the clamping element 36 has a slot curved about the release element 32, into which a pin of the catch element 34 engages. The cover 20 covers the latch 24, the catch element 34, the clamping element 36 and the springs 38 and 40 and protects said elements from soiling.

In the positions of use normally, i.e. in normal use of the seat, the latch 24 is held (secured) by the clamping element 36 in its position and the catch element 34 is arranged at a short distance (relative to the dimensions of the latch 24) from the latch 24, preferably bearing against a stop of the fitting upper part 14. In the event of a crash, if crash forces act on the latch 24, which for example exert a high torque on the fitting upper part 14, the clamping element 36 may open due to the absence of self-locking. After a very slight pivoting motion of the latch 24, said latch bears against the catch element 34. The catch element 34 supports, therefore, the latch 24, which bears within the self-locking region on the catch element 34, preferably tangentially or concentrically and as flat as possible. Thus, the latch 24 is prevented from opening. Thus, the above-disclosed locking device (consisting of the latch 24, the detent element 16 as a counter element and the catch element 34 and the clamping element 36 as securing elements) locks the fitting upper part 14 (and thus the freely-pivoting unit 12) both normally and in the event of a crash.

On the side of the fitting upper part 14 remote from the cover 20, an unlocking lever 46 is connected fixedly in terms of rotation to the release element 32, to which a first control cable 48, in operative connection with the freely-pivoting operating element 8, is fastened. Alternatively, the release element 32 may also be actuated via an electrical actuator, for example a servomotor or the like. For unlocking the fitting upper part 14 by means of the freely-pivoting operating element 8, by means of the first control cable 48 (and the unlocking lever 46) the release element 32 is rotated about its own axis. The release element 32 drives the catch element 34 connected fixedly in terms of rotation therewith, which drives and thus opens the clamping element 36, by means of the slotted pin guide 44—after passing the free travel, i.e. the clamping element 36 is separated from the latch 24 and moved away. The latch 24 is, as a result, released and may open automatically due to the absence of self-locking. In a modified embodiment, the catch element 34 may bear against an unlocking finger of the latch 24 and pull said latch with the further pivoting motion.

In the present embodiment, the two fittings 5 are configured slightly differently on the two vehicle seat sides. The freely-pivoting unit 12 of the fitting 5 of the one vehicle seat side is also described further hereinafter.

In said fitting 5, on the fitting upper part 14, in particular on the collar thereof (or other projection) (or possibly on the detent element 16) a switching ring 50 is rotatably mounted concentrically to the axis A. The switching ring 50 is arranged in the axial direction between the detent element 16 and the fitting upper part 14 (i.e. within the above-mentioned constructional space). The switching ring 50 has a switching contour 52, in the present case a radially projecting step, which is arranged in the lower region of the fitting upper part 14. The switching ring 50 further comprises a radially projecting switching finger 54 and a spring mounting 56, also radially projecting, which are both arranged in the upper region of the fitting upper part 14. The other end of the arresting spring 40 is suspended on the spring mounting 56. The switching finger 54 is located in the pivoting region of the catch element 34 which preferably has a radially projecting actuating arm 34a for cooperating with the switching finger 54. On the fitting upper part 14, a securing latch 64 is pivotably mounted by means of a securing pin 62. The securing latch 64 is prestressed by means of a securing spring 66 against the switching ring 50 and bears with its free end within the recess 16a on the switching ring 50 or on the stop 17. The last-mentioned possibility for bearing is available depending on the inclination of the backrest 2 set by the adjustment fitting 11 and possibly the wobble motion between the fitting parts of the adjustment fitting 11.

On the fitting lower part 9 provided on this vehicle seat side, an operating lever 73 is pivotably mounted in the vicinity of the stop 17 by means of a switching pin 71 parallel to the axis A. A locking washer 75 secures the operating lever 73 on the switching pin 71. A switching spring 77 configured as a helical-tension spring is, on the one hand, suspended on the operating lever 73 and, on the other hand, fastened to the fitting lower part 9, for example suspended on a spring bolt 79, which projects from the fitting lower part 9 parallel to the switching pin 71. The switching spring 77 prestresses the operating lever 73 against the stop 17, the free end of the operating lever 73 being arranged in the immediate vicinity of the switching ring 50.

The vehicle seat 1 is able to be longitudinally adjusted by means of a longitudinal adjuster 81, i.e. adjustable in the longitudinal seat position. To this end, the longitudinal adjuster 81 comprising two seat rail pairs may be unlocked by means of a handle 83 and automatically locks after releasing the handle 83. The longitudinal adjuster 81 is, however, also unlocked when freely pivoting the backrest 2, so that the vehicle seat 1 (by means of the longitudinal adjuster 81) may be moved to the front, in order to facilitate access to the rear, in addition to the free-pivoting of the backrest 2. The unlocking of the longitudinal adjuster 81 takes place, therefore, directly by means of the freely-pivoting operating element 8 or indirectly, as on the vehicle seat side without a switching ring 50 an unlocking ring 84 is provided in the fitting 5, instead of said switching ring, which is driven in a manner known per se when pivoting forward the backrest 2 and thus by means of a Bowden cable or the like controls the locking of the longitudinal adjuster 81.

A memory device of the longitudinal adjuster 81, by means of which the longitudinal seat position (memory position) set before the free-pivoting may be located, is operatively connected by means of a second control cable 89, preferably a Bowden cable, with the fitting 5 which has the switching ring 50. The second control cable 89 is fastened to an arm of the operating lever 73, i.e. the memory device of the longitudinal adjuster 81 controls the operating lever 73, in order to be able to release the securing latch 64.

The free-pivoting of the backrest 2 which is caused by means of the freely-pivoting operating element 8, starts with the unlocking of the fitting upper part 14 on both vehicle seat sides. The latch 24 is lifted in the manner described above radially from the second detent stop 28 of the detent element 16. With the pivoting motion of the backrest 2 to the front, the securing latch 64 slides with its free end along the switching ring 50 and thus reaches the stop 17. An oblique contour on the securing latch 64 ensures that the securing latch 64 which is brought to bear against the stop 17 slightly pivots up with the further pivoting motion of the backrest 2 and slides along the underside of the stop 17.

After passing the stop 17, the stop contour is set back radially for the securing latch 64. By means of its prestressing, the securing latch 64 now falls behind the stop 17 (radially inside) and engages behind said stop with a securing latch contour 64, and namely outside the self-locking region. Thus it displaces the operating lever 73 which again engages behind the securing latch 64 and preferably positively secures said securing latch with a corresponding operating lever contour 73a. The pivoting motion of the backrest 2 is completed and the fitting upper part 14 (and thus the backrest 2) secured. The pivoted-forward backrest 2 is now located in the freely-pivoted position which permits unhindered access to the rear. At the same time, the vehicle seat 1 is in a forward longitudinal seat position.

In order to return to the previously adopted position of use, firstly the vehicle seat 1 is again moved to the rear, for example by pulling on the backrest 2. When the memory position is reached, the longitudinal adjuster 81 is locked and thus pulls on the second control cable 89. The second control cable 89 now pivots the operating lever 73, which releases the securing latch 64. The backrest 2 opens the securing latch 64 by the commencement of its rearward pivoting motion and may then be pivoted back unhindered. The latch 24 thus reaches the second detent stop 28 again and when reaching the previously adopted position of use again falls behind the second detent stop 28 (radially inside) so that the fitting upper part 14 and thus the fitting 5 are again locked. The operating lever 73, which is not further acted upon by the second control cable 89, is pulled back by the associated switching spring 77 again into its initial position.

If the memory position is not reached, for example due to objects in the foot well—instead of the previously described automatic opening—the securing of the backrest 2 may be manually opened by means of the freely-pivoting operating element 8. As a result, by means of the first control cable 48 the release element 32 is rotated, which pivots the catch element 34. The catch element 34 presses by means of its actuating arm 34a onto the switching finger 54 of the switching ring 50. Due to an oblique portion provided there the switching ring 50 is rotated, whereby the switching contour 52 comes to bear against the operating lever 73, and opens said operating lever. The operating lever 73, as a result, releases the securing latch 64. As described above, the backrest 2 may now be pivoted back.

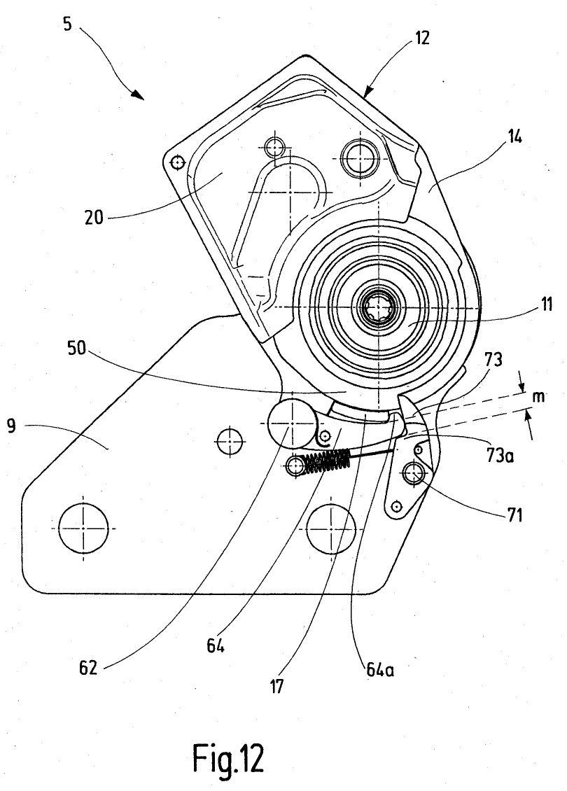

The securing of the fitting upper part 14 by means of the securing latch 64 in the freely-pivoted position of the backrest 2 is, in the present case, designed so that the wobble loop of the adjustment fitting 11 has no influence. As is visible from FIGS. 11 and 12, due to the wobble loop the securing pin 62 adopts different positions relative to the stop 17. However, this only has an effect on the support of the securing latch 64 on the stop 17 and on the support of the locking lever 73 on the securing latch 64 at an angle which is compensated by a suitable shape of the securing latch contour 64a and the locking lever contour 73a. Ultimately, the same degree of closing m is always produced, i.e. the spacing between the two bearing points (securing latch—stop, locking lever—securing latch) is constant.

While a specific embodiment of the invention has been described in detail to illustrate the application of the principles of the invention, it will be understood that the invention may be embodied otherwise without departing from such principles.

In the claims:

1. A fitting for a vehicle seat, the fitting comprising:
an adjustment fitting for the inclination adjustment of a backrest of the vehicle seat relative to a seat part of the vehicle seat;
a freely-pivoting unit for the central free-pivoting of the backrest from at least one position of use into a freely-pivoted position
a freely-pivoting operating element, said freely-pivoting unit being triggered by means of the freely-pivoting operating element;
a fitting lower part, which may be connected to the seat part and which carries the adjustment fitting;
a longitudinal adjuster for longitudinal adjustment of the vehicle seat;
a fitting upper part associated with the freely-pivoting unit, which may be connected to the backrest, and which is locked in the position of use; and
a securing latch which is pivotably articulated to the fitting upper part and which secures the fitting upper part in the freely-pivoted position of the backrest, the securing latch being able to be opened at least by means of the freely-pivoting operating element wherein the securing latch secures the fitting upper part to the fitting lower part and the securing latch securing the fitting upper part may also be opened by means of the longitudinal adjuster of the vehicle seat.

2. The fitting as claimed in claim 1, wherein for limiting the inclination adjustment of the backrest a stop is provided on the fitting lower part and a detent element cooperating with the stop is provided on the adjustment fitting.

3. The fitting as claimed in claim 1, wherein the freely-pivoting unit comprises a locking device with a latch for locking the fitting upper part in the position of use, a prestressed clamping element for securing the locked latch during normal operation and a catch element for supporting the latch in the event of a crash.

4. The fitting as claimed in claim 3, wherein:
the latch is pivotably articulated to the fitting upper part; and
the freely-pivoting unit comprises a detent element which is connected to the adjustment fitting and by which the latch is locked.

5. The fitting as claimed in claim 1, wherein the securing latch cooperates for securing the fitting upper part with a stop on the fitting lower part, the stop defining the inclination adjustment.

6. The fitting as claimed in claim 5, wherein the securing latch, in the position of use, bears against a component of the freely-pivoting unit and/or during the free-pivoting of the backrest, slides along a component of the freely-pivoting unit until reaching the stop.

7. The fitting as claimed in claim 6, wherein the securing latch brought to bear against the stop slightly pivots upward with the further pivoting motion of the backrest and slides along the underside of the stop until it engages behind the stop after passing the stop by means of a securing latch contour in a non-self-locking manner.

8. The fitting as claimed in claim 5, wherein the securing latch is prestressed with the securing latch cooperating with the stop for securing, the securing latch being secured by a prestressed operating lever by means of an operating lever contour.

9. The fitting as claimed in claim 7, wherein:
the securing latch is prestressed with the securing latch cooperating with the stop for securing, the securing latch being secured by a preferably prestressed operating lever by means of an operating lever; and
the securing latch contour and the operating lever contour are configured such that a degree of closing is produced, which is independent of a wobble motion of the adjustment fitting.

10. The fitting as claimed in claim 8, wherein the freely-pivoting unit comprises a rotatably mounted switching ring, which may be rotated by means of the freely-pivoting operating element, the rotated switching ring acting on the operating lever by means of a switching contour opening the operating lever.

11. The fitting as claimed in claim 3, wherein:
the freely-pivoting unit comprises a rotatably mounted switching ring, which may be rotated by means of the freely-pivoting operating element, the rotated switching ring acting on the operating lever by means of a switching contour opening the operating lever; and
the actuated freely-pivoting operating element, by means of a first control cable, pivots the catch element, which acts on the switching ring, in order to rotate said switching ring.

12. The fitting as claimed in claim 8, wherein the longitudinal adjuster, in particular a memory device of the longitudinal adjuster, when reaching the previously set longitudinal seat position, in particular by means of a second control cable, acts on the operating lever, in particular opens the operating lever.

13. A vehicle seat comprising:
a backrest which may be adjusted in its inclination and is freely pivotable;
a longitudinal adjuster by means of which the vehicle seat when freely pivoting the backrest may be moved to the front; and
a fitting for adjusting the inclination and for freely pivoting the backrest, said fitting comprising:
an adjustment fitting for the inclination adjustment of the backrest of the vehicle seat relative to a seat part;
a freely-pivoting unit for a central free-pivoting of the backrest from at least one position of use into a freely-pivoted position;
a freely-pivoting operating element, said freely-pivoting unit being triggered by means of the freely-pivoting operating element;
a fitting lower part, which may be connected to the seat part and which carries the adjustment fitting;
a fitting upper part associated with the freely-pivoting unit, which may be connected to the backrest, and which is locked in the position of use; and
a securing latch which is pivotably articulated to the fitting upper part and which secures the fitting upper part in the freely-pivoted position of the backrest, the securing latch for being opened by means of the freely-pivoting operating element wherein the securing latch secures the fitting upper part to the fitting lower part and the securing latch may also be moved to a non secured position by means of the longitudinal adjuster of the vehicle seat.

14. The vehicle seat as claimed in claim 13, wherein the longitudinal adjuster comprises a memory device, which locates the longitudinal seat position set before the free-pivoting, and then opens the securing latch.
